(19) United States
(12) Patent Application Publication
(10) Pub. No.: US 2012/0106190 A1
(43) Pub. Date: May 3, 2012

(54) LIGHT GUIDE FOCUSSING DEVICE AND METHOD

(75) Inventor: Meir Ben-Levy, Haifa (IL)

(73) Assignee: MGIC LIGHTING OPTICS LTD., Haifa (IL)

(21) Appl. No.: 13/381,785

(22) PCT Filed: Jun. 28, 2010
(86) PCT No.: PCT/IL2010/000518

§ 371 Date: Dec. 30, 2011

Related U.S. Application Data
(60) Provisional application No. 61/221,603, filed on Jun. 30, 2009.

(51) Int. Cl. G02B 6/00

(52) U.S. Cl. 362/551

(57) ABSTRACT

A device and method for directing light from a non directed light source into a forward direction with a required angular distribution. The device may comprise a tapered light guide, a front refractor and a back reflector. The wedge angle of the light guide is selected such that light incident upon the entrance of the light guide and exits the light guide and is directed either by the front refractor or the back reflector into the desired angular distribution.

### FIELD OF THE INVENTION

The present invention relates to light focusing devices. In particular embodiments described herein relate to light guides configured to direct light within a desired angular distribution.

### BACKGROUND

The development of products for manipulating light has led to a broad portfolio of technologies that filter, split, attenuate, switch, combine, and monitor light. Controlling the angular distribution of light sources is an important aspect in a broad range of applications serving the industrial, medical and scientific communities. Examples of this need include spot light, stage lighting for public appearances, concerts, theatres and the like, where the illumination is controlled via directed light. Other examples include the illumination of small areas such as may be needed during dental and surgical procedures.

Automobile headlights are a particular application in which the field of illumination is dictated by the dual needs both to provide the driver with good road vision as well as to prevent glare to oncoming traffic. Furthermore, headlights are commonly configured to conform to various national standards. Recently, technologies such as Light Emitting Diode (LED) lighting have become applicable to automobile lighting, where headlamps using LED lighting elements are now a possibility. Efficient ways to direct light from automobile headlights for example are continually being developed.

Traditional light direction methods include reflecting elements, such as curved mirrors, positioned behind a light source, and refracting elements, such as lenses positioned in front of light sources. These methods as well as the problems associated therewith are well known in the art. For example, it is difficult to locate multiple light sources, such as double filament bulbs LED arrays and the like, at a single focal point.

There is therefore a need for efficient, cost effective solutions for controlling the angular distribution of light sources. The devices disclosed herein address this need.

### SUMMARY OF THE INVENTION

A light directing device is herein disclosed configured to direct light forwards with a required angular distribution. The device comprises at least one tapered light guide and at least one front refractor. The tapered light guide comprises a front out-coupling surface, a rear out-coupling surface and an in-coupling entrance subtending a wedge-angle β at an apex of the front out-coupling surface and the rear out-coupling surface. The refractor comprises a rear in-coupling surface and a forward facing out-coupling surface and is positioned such that the rear in-coupling surface of the refractor is adjacent to the front out-coupling surface of the light guide with an intermediate gap therebetween. The wedge-angle β is selected such that light incident upon the in-coupling entrance of the light guide and exiting from the front out-coupling surface of the -light guide is incident upon the rear in-coupling surface of the refractor and is transmitted across the forward facing out-coupling surface of the refractor with the required angular distribution.

Optionally, the tapered light guide may have rotational symmetry about an external axis through the in-coupling entrance. Where appropriate, the value of the wedge angle β may vary with angle ψ about a central axis such that the required angular distribution is not symmetrical.

The light directing device may further comprise at least one rear reflector configured such that light incident upon the in-coupling entrance of the light guide and exiting from the rear out-coupling surface is reflected forward with the required angular distribution. Optionally, the rear reflector comprising an optical element maybe positioned adjacent to the rear out-coupling surface of the light guide, the optical element configured to direct light exiting the rear out-coupling surface of the light guide within the required angular distribution via total internal reflection.

In selected embodiments, the half-aperture angle between a central axis and a centerline extending from the in-coupling entrance to the apex of the front out-coupling surface and the rear out-coupling surface may be approximately equal to the critical angle limiting total internal reflection by the front out-coupling surface of the light guide. Optionally, the half-aperture angle between a central axis and a centerline extending from the in-coupling entrance to the apex of the front out-coupling surface and the rear out-coupling surface lies within the range (sin−1(1/n)−β) to (sin−1(1/n)+β) where n is the refractive index of the light guide and β is the wedge angle.

The light guide may have a circular horizontal cross section wherein the front out-coupling surface has a generally concave conical shape characterized by a first cone angle. Optionally, the rear out-coupling surface has a generally truncated convex conical shape characterized by a second cone angle. The first cone angle may be greater than the second cone angle. Advantageously, the first cone angle and the second cone angle are selected such that light incident upon the in-coupling entrance of the light guide is distributed with the required angular distribution.

Optionally, the light directing device further comprises at least one light source.

Another aspect of the invention is to teach method for use directing light forwards with a required angular distribution. The method may comprise: providing a light source; providing at least one tapered light guide comprising a front out-coupling surface, a rear out-coupling surface and an in-coupling entrance subtending a wedge-angle at an apex of the front out-coupling surface and the rear out-coupling surface; positioning at least one refractor, comprising a rear in-coupling surface and a forward facing out-coupling surface, such that the rear in-coupling surface of the refractor is adjacent to the front out-coupling surface of the light guide with an intermediate gap therebetween; and selecting the wedge-angle such that light incident upon the in-coupling entrance of the light guide and exiting from the front out-coupling surface of the light guide is incident upon the rear in-coupling surface of the refractor and is transmitted across the forward facing out-coupling surface of the refractor with the required angular distribution.

The method may further comprise selecting a half-aperture angle between a central axis and a centerline extending from the in-coupling entrance of the light guide to the apex of the front out-coupling surface and the rear out-coupling surface which is approximately equal to the critical angle limiting total internal reflection by the front out-coupling surface of the light guide. Optionally, the step of selecting a half-aperture angle comprises selecting an angle within the range (sin−1(1/n)−β) to (sin−1(1/n)+β) where n is the refractive index of the light guide and β is the wedge angle.

The method may further comprise providing a rear reflector such that light exiting the rear out-coupling surface of the light guide is reflected forward with the required angular distribution. Optionally, the step of providing the rear reflector comprises positioning an optical element adjacent to the rear out-coupling surface of the light guide with an intermediate gap.

### BRIEF DESCRIPTION OF THE FIGURES

For a better understanding of the invention and to show how it may be carried into effect, reference will now be made, purely by way of example, to the accompanying drawings.

With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention; the description taken with the drawings making apparent to those skilled in the art how the several forms of the invention may be embodied in practice. In the accompanying drawings:

FIG. 1 represents a schematic cross section of a lighting system incorporating an exemplary light directing device as disclosed herein;

FIG. 2a represents a schematic sliced cross section of a tapered light guide for use in the light directing device;

FIG. 2b represents a schematic top view of the tapered light having circular configuration;

FIG. 3 represents a schematic cross section of a possible rear reflector for use with the light directing device;

FIG. 4 represents a schematic cross section of a possible front refractor for use with the light directing device;

FIG. 5 shows a ray tracing diagram of the lighting system of FIG. 1 showing how light propagates through the wave guide and exits with a required angular distribution; and

FIG. 6 shows a possible required angular distribution 300 for the illumination provided by the lighting system;

FIG. 7 is a flowchart of a method for directing light into a required angular distribution as disclosed herein;

FIG. 8a is a graph showing the simulated variation of illuminance over a meter square at a distance of one meter from a model lighting system; and

FIG. 8b is a graph showing how the luminous intensity varies with angle from the central axis for the model lighting system.

### DESCRIPTION OF THE PREFERRED EMBODIMENTS

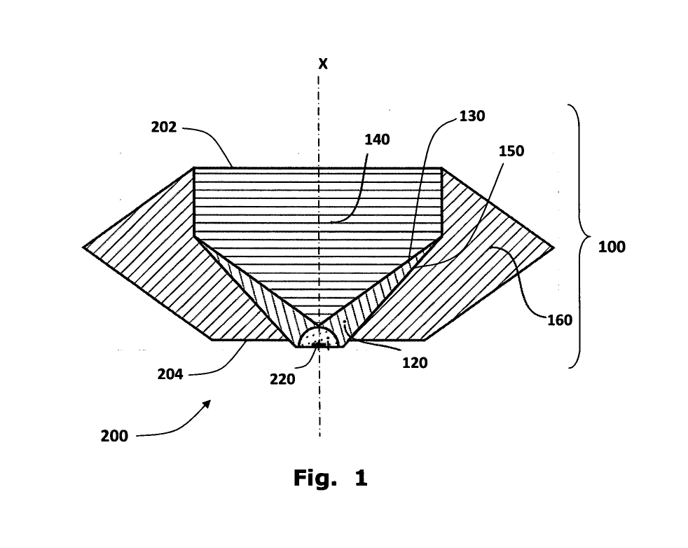

Reference is now made to FIG. 1 showing a lighting system 200 incorporating a light directing device 100 as disclosed herein. The lighting system 200 is configured to produce an illuminating beam having a specified angular distribution about a central axis X. The lighting system 200 includes a typically non-directed light source 220 and a light directing device 100. The side of the lighting system 200 via which the illuminating beam is emitted is known herein as the front 202 and the reverse side is known as the rear 204.

The light directing device 100 may be optically coupled to a variety of light sources 220 such that light is directed therethrough and out of the front face 202. It will be appreciated that, amongst others, such light sources 220 include Light Emitting Diodes (LEDs), incandescent filaments such as tungsten light sources, gas discharge burners such as High-Intensity Discharge or xenon sources and the like.

The light directing device 100 includes a tapered light guide 120, a front refractor 140 and a rear reflector 160. It is noted that the tapered light guide 120 is sandwiched between the front refractor 140 and the rear reflector 160 with intermediate air gaps 130, 150 between their interfacial surfaces.

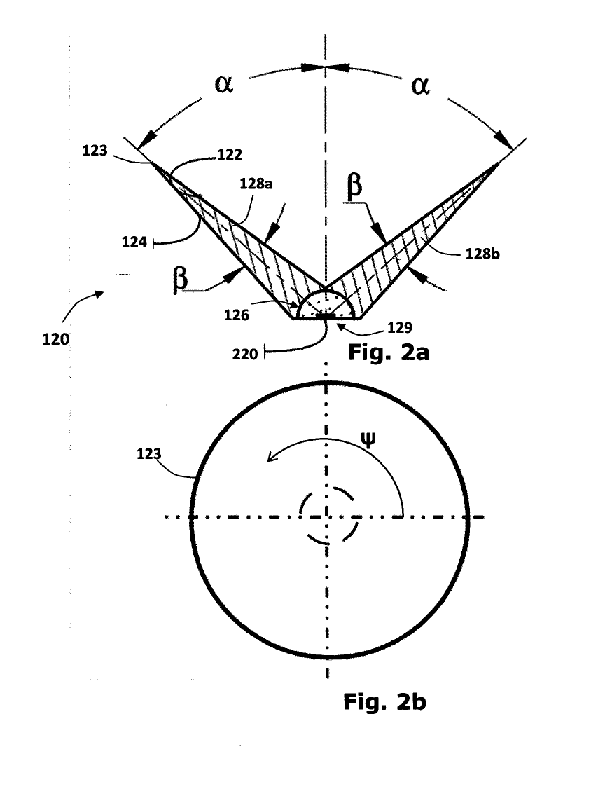

Referring now to FIGS. 2a and 2b, an example of the tapered light guide 120 is shown in cross-section and top view respectively. With particular reference to FIG. 2a, a cross-sectional slice is shown of the exemplary tapered light guide 120 coupled to the light source 220. Where appropriate, the light source 220 may be embedded into the light guide 120 to improve the efficiency of the optical coupling. The tapered light guide 120 has a front out-coupling surface 122, a rear out-coupling surface 124, an in-coupling entrance 126 and a tip 123 at the intersection of the front out-coupling surface 122 and the rear out-coupling surface 124.

The cross section of the exemplary light guide 120 has two prongs 128a, 128b forming a V shape with the light source 220 situated at the apex 129 of the V. The line through the center of each prong 128a, 128b extending from the light source 220 to the tip 123 is known as the centerline of the light guide 120. The half-aperture angle α of the light guide is defined as the angle between the centerline and the central axis X.

The in-coupling entrance 126 subtends an angle β, known as the wedge angle, at the prong tip 123. As noted in more detail below, the wedge angle β may be selected so as to provide the desired angular distribution.

It will be appreciated that although only a V shaped cross section is described hereinabove, other examples of the light guide may be contemplated having different cross sections, such as single wedge shaped prongs for example.

Referring now to FIG. 2b, the prong tip 123 of the exemplary tapered light guide 120 may describe a circle about the central axis X. Accordingly, the front out-coupling surface 122 of the tapered light guide 120 describes a concave cone and the rear out-coupling surface 124 describes a convex truncated cone with a smaller aperture. Consequently, the angular distribution of the light cone exiting the exemplary light guide 120 may have uniform rotational symmetry about the central axis X. It will be appreciated that other configurations may be selected according to requirements such as hexagonal, heptagonal, octagonal light guides and so on.

Indeed, where non-symmetrical angular distribution of the light is required, the tapered light guide 120 may have other shapes not demonstrating rotational symmetry. Light guides may therefore be provided in which the wedge angle β varies as a function of the angle ψ about the central axis, the function β(ψ) being selected to suit requirements, possibly using optical optimization techniques as known in the art.

Still other examples of the light directing device 100 may include prismatic light guides 120 having uniform cross sections over an extended length. Such prismatic light guides may be used to provide direction to light produced by strip light sources such as fluorescent tubes or rows of LEDs for example.

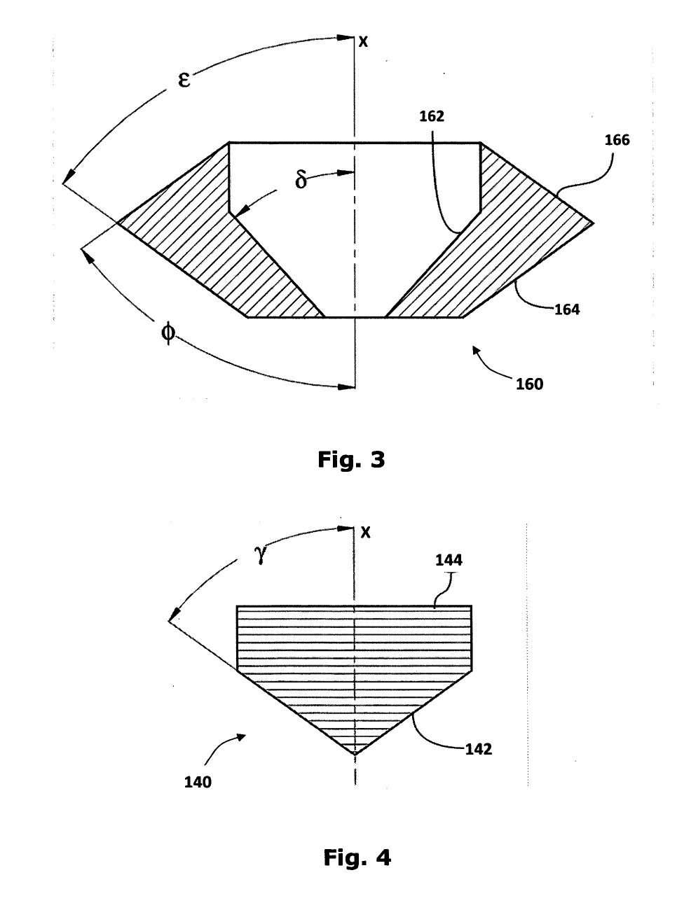

Reference is now made to FIG. 3 representing a cross-section of an exemplary rear reflector 160 which may be used in examples of the light directing device 100 (FIG. 1) disclosed herein. The exemplary rear reflector 160 has an in-coupling surface 162, a reflecting surface, 164 and a forward facing out-coupling surface 166.

The exemplary rear reflector 160 is a light transmitting optical element configured to surround the tapered light guide 120 such that its in-coupling surface 162 abuts the rear out-coupling surface 124 of the light guide 120 with an intermediate air gap 150. Thus the angle δ between the in-coupling surface 162 of the rear reflector 160 and the central axis X is approximately equal to the angle between the rear out-coupling surface 124 of the light guide 120 and the central axis X. As a result of this configuration, light exiting the rear out-coupling surface 124 of the light guide 120 is incident upon and enters the in-coupling surface 162 of the rear reflector 160.

The dimensions of the rear reflector 160 are selected such that light entering the in-coupling surface 162 is incident upon the reflecting surface 164. The angle ε between the reflecting surface 164 and the central axis X is selected such that this incident light undergoes total internal reflection and is directed out of the forward facing out coupling surface 166. The angle φ between the refraction surface 166 and the central axis may be selected according to the refractive index of the rear reflector 160 such that the exiting light has the desired angular distribution.

Although the exemplary rear reflector 160 described above is a light transmitting optical element. It will be appreciated that in other light directing devices, the rear reflector may comprise mirrors angled to redirect light exiting the rear out-coupling surface of the light guide 120 into the desired angular distribution. Furthermore, the rear reflector may have reflectively coated surfaces allowing for greater freedom of selection regarding its dimensions. Indeed where appropriate, the rear out coupling surface 124 of the light guide 120 may alternatively itself be coated with reflective material.

Referring now to FIG. 4, a cross section is shown of an exemplary front refractor 140 which may be used in examples of the light directing device 100 (FIG. 1) disclosed herein. The exemplary front refractor 140 has a in-coupling surface 142 and a forward facing out-coupling surface 144.

The exemplary front refractor 140 is a light transmitting optical element configured to nest within the tapered light guide 120 such that the in-coupling surface 142 of the front refractor 140 abuts the front out-coupling surface 122 of the light guide 120 with an intermediate air gap 130. Thus the angle γ between the in-coupling surface 142 of the front refractor 140 and the central axis X is approximately equal to the angle between the front out-coupling surface 122 of the light guide 120 and the central axis X. As a result of this configuration, light exiting the front out-coupling surface 122 of the light guide 120 is incident upon and enters the in-coupling surface 142 of the front refractor 140.

The dimensions of the front refractor 140 are selected according to the refractive index such that light entering the in-coupling surface 142 is refracted out of the forward facing out-coupling surface 144 with the desired angular distribution.

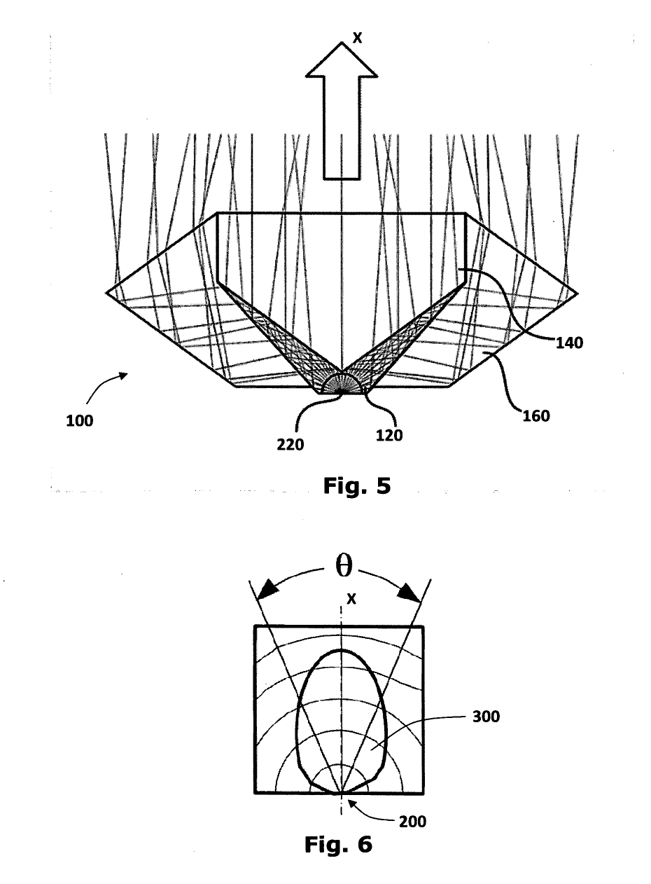

Referring to FIG. 5, showing a ray tracing diagram of the lighting system 200, it is noted that light emitted from the non-directional light source 220, propagates through the light guide 120 by a series of total internal reflections off the sides of the out-coupling surfaces 122, 124. When the angle of incidence of the light beams with the out-coupling surfaces 122, 124 is below the critical angle, the conditions for total internal reflection no longer apply and therefore the light is transmitted through either front out-coupling surface 122, or the rear out-coupling surface 124.

As noted above, it is a particular feature of the lighting system 200, that light transmitted through the front out-coupling surface 122 pass through the front refractor 140 and light transmitted through the rear out-coupling surface 124 pass through the rear reflector 160. Accordingly ray tracing techniques may be used to select the angles α, β, γ, δ, ε, φ such that light exiting the light directing device 100 has the desired angular distribution.

The exemplary light directing device 100 typically has a circular cross section such that the angles α, β, γ, δ, ε, φ are uniform cone angles. It will be appreciated that the terms cone, conical shape and the like, as used herein may refer to shapes with variations from the geometrical definitions of the cone. For example, other light directing devices may have polygon based pyramid shapes and may have local variations particularly near the cone apex or close to the truncation region. Moreover, where required, the angles α, β, γ, δ, ε, φ may vary with angle ψ about the central axis X (FIG. 2b) such that various fields of illumination may be achieved having non symmetrical angular distributions.

So as to better illustrate the use of the light directing device 100 disclosed herein, the following model is presented demonstrating one possible set of assumptions and estimations used in the selection of the angles and dimensions of the device. Referring now to FIG. 6, a possible desired angular distribution 300 of illumination is shown which may be provided by the lighting system 200 including the exemplary light directing device 100.

The angle θ is the Full Width Half Maximum (FWHM) of the angular distribution of the light exiting the light directing device 100. It will be appreciated that the smaller the value of θ, the more concentrated the illumination.

One useful approximation relates the FWHM to the wedge angle β (FIG. 2a) according to the linear relationship:

0˜nβ (1)

where n is the refractive index of the light guide 120.

Equation (1) implies that the smaller the wedge angle the more concentrated the light exiting the light directing device 100.

Another approximation relates to the half-aperture angle α of the light guide 120 (FIG. 2a). The angle α determines the general direction of light transmitted to the front refractor 140. In order to achieve a high concentration of light, the half-aperture angle α may be selected such that the direction of transmission of light from the light guide 120 to the front refractor 140 is approximately parallel to the central axis X. Such a configuration may be achieved by selecting a half-aperture angle α approximately equal to the critical angle limiting total internal reflection as follows:

α≈sin⁻¹(1/n) (2)

where n is the refraction index of the light guide 120.

To compensate for Fresnel reflections and variations in refractive index, the value of the half-aperture angle α may be selected to lie between the following limits:

sin⁻¹(1/n)−β<α<sin⁻¹(1/n)+β (3)

where n is the refraction index of the light guide 120 and β is the wedge angle (FIG. 2a).

The angle γ between the in-coupling surface 142 of the front refractor 140 and the central axis X is approximately equal to the angle between the front out-coupling surface 122 of the light guide 120 and the central axis X. It may be shown that this angle γ is related to the wedge angle β and the half-aperture angle α according to the relationship

γ≈α+β/2 (4)

it is noted that variations of few degrees may allow for improved mechanical fitting and to reduce Fresnel reflections.

Similarly, the angle δ between the in-coupling surface 162 of the rear reflector 160 and the central axis X is approximately equal to the angle between the rear out-coupling surface 124 of the light guide 120 and the central axis X. It may be shown that the angle δ is related to the wedge angle β and the half-aperture angle α according to the relationship:

δ≈α−β/2 (5)

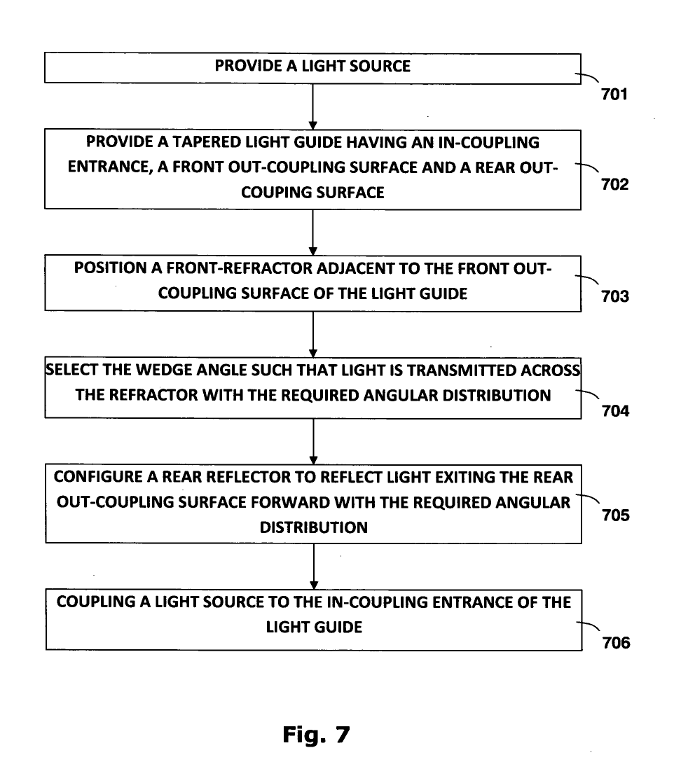

Referring now to the flowchart of FIG. 7, a method is represented for directing light with a required angular distribution. The method includes the steps: providing a light source 701; providing a tapered light guide having an in-coupling entrance, a front out-coupling surface and a rear out-coupling surface 702; positioning a front-refractor adjacent to the front out-coupling surface of the light guide 703; selecting the wedge angle β such that light incident upon the in-coupling entrance of the light guide and exiting from the forward out-coupling surface is incident upon the rear in-coupling surface of the refractor and is transmitted across the forward facing out-coupling surface of the refractor with the required angular distribution 704; configuring a rear reflector to reflect light exiting the rear out-coupling surface with the required angular distribution 705; and coupling the light source to the in-coupling entrance of the light guide 706.

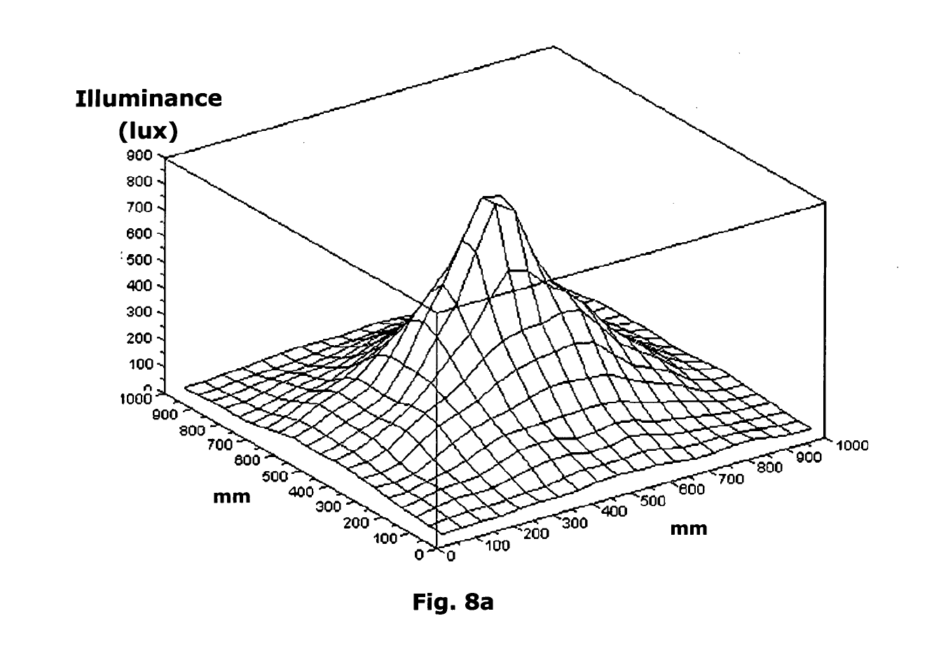

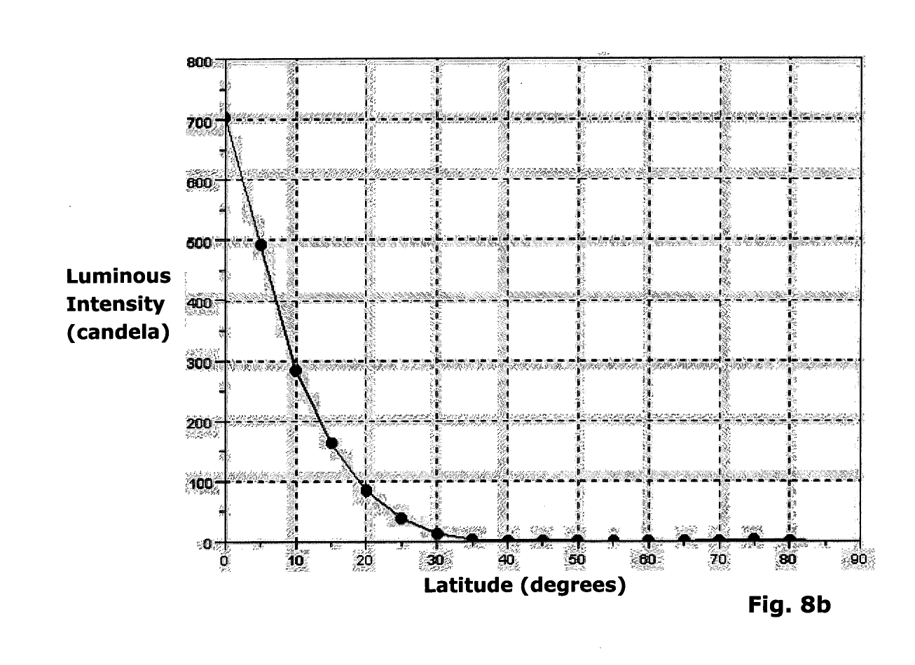

Reference is now made to FIGS. 8a and 8b showing selected results of a simulated model lighting system. The simulation was run using optical engineering software LightTools® using a 2 mm diameter Light Emitting Diode (LED) light source having a flux of 145 lumens and a light directing system as disclosed herein.

With particular reference to FIG. 8a, the variation of illuminance in lux is represented of a one meter square area at a distance of one meter from the lighting system. It will be apparent that the light directing device has successfully directs the light forward close to the central axis X. The angular distribution is represented in FIG. 8b which shows a graph of luminous intensity in candelas against angle from the forward central axis X.

The scope of the present invention is defined by the appended claims and includes both combinations and sub combinations of the various features described hereinabove as well as variations and modifications thereof, which would occur to persons skilled in the art upon reading the foregoing description.

In the claims, the word “comprise”, and variations thereof such as “comprises”, “comprising” and the like indicate that the components listed are included, but not generally to the exclusion of other components.

1. A light directing device configured to direct light forwards with a required angular distribution, the device comprising:
at least one substantially circular tapered light guide having a substantially conical shaped front out-coupling surface, a substantially conical shaped rear out-coupling surface, and an in-coupling entrance subtending a wedge-angle β at an apex of the front out-coupling surface and the rear out-coupling surface;
at least one front refractor having a substantially conical shaped rear in-coupling surface and a forward facing out-coupling surface, wherein said at least one front refractor is positioned such that the rear in-coupling surface is adjacent to the front out-coupling surface with an intermediate gap therebetween,
wherein: light incident upon said in-coupling entrance propagates radially along the light guide and exiting from the front out-coupling surface with a limited angular distribution smaller or equal to a critical angle of the light guide is incident upon the rear in-coupling surface and is transmitted across the forward facing out-coupling surface with the required angular distribution.

2. The light directing device of claim 1, wherein said tapered light guide having rotational symmetry about an external axis through said in-coupling entrance.

3. The light directing device of claim 1 wherein the value of the wedge angle β varies with angle ψ about a central axis such that the required angular distribution is not symmetrical.

4. The light directing device of claim 1, the device further comprising at least one rear reflector.

5. The light directing device of claim 4, wherein said rear reflector comprising an optical element positioned adjacent to the rear out-coupling surface, said optical element configured to direct light exiting the rear out-coupling surface within the required angular distribution via total internal reflection.

6. The light directing device of claim 1, wherein a half-aperture angle between a central axis and a centerline extending from the in-coupling entrance to the apex of said front out-coupling surface and said rear out-coupling surface is approximately equal to the critical angle limiting total internal reflection by the front out-coupling surface of the light guide.

7. The light directing device of claim 1, wherein the half-aperture angle between a central axis and a centerline extending from the in-coupling entrance to the apex of said front out-coupling surface and said rear out-coupling surface lies within the range (sin⁻¹(1/n)−β) to (sin⁻¹(1/n)+β) where n is the refractive index of the light guide and β is the wedge angle.

8. The light directing device of claim 1, said light guide has a circular horizontal cross section and wherein said front out-coupling surface has a generally concave conical shape characterized by a first cone angle.

9. The light directing device of claim 8, wherein said rear out-coupling surface has a generally truncated convex conical shape characterized by a second cone angle.

10. The light directing device of claim 9 wherein said first cone angle is greater than said second cone angle.

11. The light directing device of claim 9 wherein the first cone angle and the said second cone angle are selected such that light incident upon said in-coupling entrance of said light guide is distributed with said required angular distribution.

12. The light directing device of claim 1, the device further comprising at least one light source.

13. A method of directing light forwards with a required angular distribution comprising:
providing a light source;
providing at least one tapered light guide comprising a front out-coupling surface, a rear out-coupling surface and an in-coupling entrance subtending a wedge-angle at an apex of said front out-coupling surface and said rear out-coupling surface;
positioning at least one refractor, comprising a rear in-coupling surface and a forward facing out-coupling surface, such that the rear in-coupling surface of the refractor is adjacent to the front out-coupling surface of the light guide with an intermediate gap therebetween; and
selecting said wedge-angle such that light incident upon said in-coupling entrance of the light guide and exiting from the front out-coupling surface of the light guide is incident upon the rear in-coupling surface of the refractor and is transmitted across the forward facing out-coupling surface of said refractor with said required angular distribution.

14. The method of claim 13 further comprising: selecting a half-aperture angle between a central axis and a centerline extending from the in-coupling entrance of the light guide to the apex of said front out-coupling surface and said rear out-coupling surface which is approximately equal to the critical angle limiting total internal reflection by the front out-coupling surface of the light guide.

15. The method of claim 14 wherein selecting a half-aperture angle comprises: selecting an angle within the range (sin⁻¹(1/n)−β) to (sin⁻¹(1/n)+β) where n is the refractive index of the light guide and β is the wedge angle.

16. The method of claim 13 further comprising: providing a rear reflector such that light exiting said rear out-coupling surface of the light guide is reflected forward with said required angular distribution.

17. The method of claim 16 wherein providing the rear reflector comprises: positioning an optical element adjacent to the rear out-coupling surface of the light guide with an intermediate gap.

18. The light directing device of claim 10, wherein the first cone angle and the said second cone angle are selected such that light incident upon said in-coupling entrance of said light guide is distributed with said required angular distribution.
